(19) United States
(12) Patent Application Publication
(10) Pub. No.: US 2025/0113150 A1
(43) Pub. Date: Apr. 3, 2025

(54) A hearing aid having improved electrical charge contacts

(71) Applicant: Oticon A/S, Smørum (DK)

(72) Inventors: Saeed Doagou RAD, Smørum (DK); Peter SPRAGGE, Smørum (DK)

(21) Appl. No.: 18/888,220

(22) Filed: Sep. 18, 2024

(30) Foreign Application Priority Data
Sep. 28, 2023 (EP) 23200471.3

(51) Int. Cl. H04R 25/00

(52) U.S. Cl. CPC H04R 25/65

(57) ABSTRACT

Disclosed herein are embodiments of a hearing aid. The hearing aid can include a number of electric charge contact, wherein the electric charge contact is a metallic component configured to provide electrical conduction. A coating at least partially covers the metallic component, the coating including a first layer at least partially located on the metallic component, wherein the first layer is gold, and a second layer at least partially located on the first layer, wherein the second layer is palladium.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids. In particular, the present application relates to electrical charge contacts in hearing aids.

### SUMMARY

### A Hearing Aid

The present invention relates to electrical connectors, and in particular to electric charge contacts in hearing instruments and consumer electronics devices that can remain intact under harsh wear and corrosion environments.

In an aspect of the present application, a hearing aid is disclosed. The hearing aid includes a processing unit, a battery unit, and an electric charge contact. The electric charge contact includes a metallic component. The metallic component can be configured to provide electrical conduction. The electric charge contact further includes a coating. The coating can at least partially cover the metallic component. The coating includes a first layer. The first layer is at least partially located on the metallic component. The first layer comprises gold. The coating comprises a second layer. The second layer is at least partially located on the first layer. The second layer comprises palladium.

Also disclosed herein are embodiments of an electric charge contact. The electric contact includes a metallic component. The metallic component can be configured to provide electrical conduction. The metallic component is covered at least partially by a coating. The coating includes a first layer. The first layer is at least partially located on the metallic component. The first layer comprises gold. The coating comprises a second layer. The second layer is at least partially located on the first layer. The second layer comprises palladium.

Many hearing aids, and other electronic devices, rely on electric charge contacts (e.g., electric contacts, electrical contacts, power contacts, conductive contact, for example highly conductive contacts) to provide sufficient charging and/or communication. The charging contacts in the hearing aid will typically be used daily, e.g., have a very high number of wear cycle during the lifetime of the instrument.

Moreover, the electric charge contacts, due to the nature of their application, are exposed to voltages, such as in the range of 4-6 V, which can expedite the corrosion in the electric charge contacts. Further, application of electric charge contacts in hearing instruments and/or other wearable devices increase the exposure rates to harsh environments for corrosion performance that include acid, salt, etc.

Most contacts for electric charge charging/communication systems for consumer electronics and hearing devices use copper alloys as the base material and gold plating as the top plating layer. This combination is selected due to the relatively easy formation of copper alloy and very low electrical resistance of gold on the top layer. However, this system is prone to failure in the long terms if both wear and corrosion application are involved leading to lower lifetimes or very thick gold layers adding to the cost due to the high usage of noble materials. For example, depending on base material and surface finish of the connector, 2.5 μm or more of gold plating is required in current electronics to develop a fully pore-free layer that will provide the best barrier protection against corrosion of the base material. Heavier gold deposits in this range provide sufficient material to allow for very high cycle applications of 10,000 cycles or more when properly engineered with the proper underplate.

Accordingly, typical electric charge contacts for hearing aids have a high potential for failure. Further, they can require large amounts of gold, greatly increasing the cost. Advantageously, the disclosed hearing aids with electric charge contacts can greatly increase the lifetime of the electric charge contacts, and thus the hearing aids themselves. Specifically, embodiments of the disclosed hearing aids can have improved corrosion performance as well as wear performance, both of which are a known problems in the field. Moreover, unnecessarily thick layers of gold are not needed to achieve these performances, thereby decreasing the costs and size of the hearing aids.

Moreover, the application of thicker gold layers known in the art makes the soldering process complicated, leading to brittle solder joints and higher tolerances of assembly. The high surface tension in gold top layer leads to highly wet surface with tin which makes the processes difficult to control.

Advantageously, embodiment of the disclosed hearing aid allows for a simple soldering process. For example, the use of palladium allows for a stable tin travel in a soldering oven, in turn improving soldering joint strengths.

Additionally, many known electric charge contacts use nickel as part of the coating. However, using nickel will add the risk of nickel release in electrical applications. This risk is in medical and wearable devices is higher due to prolonged contact with skin. According to Entry 27 of Annex XVII to REACH, the release threshold should be lower than 0.5 μg Ni/cm²/week during the lifetime of the hearing aid.

However, advantageously embodiments of the disclosed hearing aids avoid the use of nickel, thus improving the health of those persons using the hearing aids.

The hearing aid can include an electric charge contact. The hearing aid can include a plurality of electric charge contacts. The electric charge contact can also be known as an electrical contact, an electrical charge contact, a charge contact, etc. The electric charge contact can be configured to provide electrical conduction. For example, the electric charge contact can allow for electricity (e.g., electrical energy, energy) to pass through the electric charge contact. The electric charge contact can be a conductive contact. The electric charge contact can be used in one or more components of the hearing aid, such as to supply power and/or electrical energy to the components.

The electric charge contact can be configured to be exposed to voltages of 4-6V. The electric charge contact can be configured to be continually exposed to voltages of 4-6V. The electric charge contact can be configured to be exposed to voltages for a USB-C connection.

The electric charge contact can be an internal facing electric charge contact of the hearing aid. The electric charge contact can be an external facing electric charge contact of the hearing aid.

The electric charge contact can include a metallic component (e.g., metal component, metallic layer, metallic unit). The metallic component can be configured to provide electrical conduction. The electric charge contact can be any component of the hearing aid that is configured to provide electrical conduction.

In one or more example hearing aids, the metallic component includes a charging interface. In one or more example hearing aids, the metallic component includes a soldering interface. In one or more example hearing aids, the metallic component can be a charging interface and a soldering interface.

A charging interface can be understood as being configured to contact a charger device. A soldering interface can be understood as being configured to contact a substrate, such as circuit board, such as a printed circuit board.

The metallic component can be a metallic interface. The metallic component can be a metallic protrusion.

The metallic component can be steel. In one or more example hearing aids, the metallic component can be stainless steel. In one or more example hearing aids, the stainless steel is stainless steel 316 (e.g., A4 stainless steel, marine grade stainless steel). Stainless steel 316 can include iron, chromium (between 16-18%), nickel (10-12%), molybdenum (2-3%), and up to 2% manganese, with small (<1%) quantities of silicon, phosphorus & sulfur also potentially present. The metallic component can be titanium and/or a titanium alloy. The metallic component can be copper and/or copper alloys. The metallic component can be brass.

Advantageously, the metallic element can provide a hard element that is resistant to deformation. For example, the metallic component may be cold worked, such as cold worked stainless steel. The metallic element, in some implementations, can reduce any risk of debonding due to local deformations of the metallic element.

The electric charge contact can further include a coating. The coating can at least partially cover (e.g., coat, overlay, be located on) the metallic component. The coating can fully cover the metallic component. The coating can fully cover the exposed surface of the metallic component (e.g., the outer surface). For example, the metallic component can be connected to a substrate, and the coating can cover a portion of the metallic component that is not in contact with the substrate. The coating can contain no nickel in certain examples.

In one or more example hearing aids, the coating can at least partially cover a charging interface and/or a soldering interface.

In one or more example hearing aids, the coating can be formed of two layers (e.g., second layer and first layer). The first layer may also be known as a corrosion-resistant layer. The second layer may also be known as a hard layer. The two layers of the coating can contact one another at an interface between the two layers. The coating can be formed of a plurality of layers. In one or more example hearing aids, the coating may only be formed of two layers (e.g., the first layer and the second layer).

The coating can include a first layer. The first layer can be at least partially located on (e.g., coated on, overlayed on, covering) the metallic component. The first layer can be in contact with the metallic component (e.g., directly in contact). For example, there may be no additional material between the first layer and the metallic component.

In one or more example hearing aids, the first layer fully covers the metallic component. In other words, the first layer can fully cover an exposed outer surface of the metallic component.

The first layer can include gold. The first layer can be a gold layer. The first layer can be a gold-alloy layer. The first layer can be an acid gold layer. The first layer can have a hardness of HV 180-220 MPa. The first layer can be a pure gold layer with minor impurities. The first layer can be 95, 96, 97, 98, or 99% gold. The first layer can be greater than 95, 96, 97, 98, or 99% gold. The first layer can be greater than 99.0, 99.1, 99.2, 99.3, 99.4, 99.5, 99.6, 99.7, 99.8, or 99.9% gold. The first layer can include another metal, such as for hardening. For example, the first layer can be cold with one or more of cobalt, silver, or cadmium.

The coating can include a second layer. The second layer can be at least partially located on (e.g., coated on, overlayed on, covering) the first layer. The second layer can be in contact with the first layer (e.g., directly in contact). For example, there may be no additional material between the second layer and the first layer. The second layer can be considered the outer layer of the electric charge contact. For example, there may be no further layer located on top of the second layer.

In one or more example hearing aids, the second layer fully covers the first layer. In other words, the second layer can fully cover an exposed outer surface of the first layer.

The second layer can include palladium. The second layer can be a palladium layer. In one or more example hearing aids, the second layer can be pure palladium. The second layer can be pure palladium with one or more minor impurities. The second layer can be 95, 96, 97, 98, 99, or 100% palladium. The second layer can be greater than 95, 96, 97, 98, 99, or 100% palladium. The second layer can have a hardness of HV 400-600 MPa.

In one or more examples, the hardness of the second layer is at least double the hardness of the first layer. This is in contrast to many applications, where gold (e.g., of the first layer) is placed as the outer layer to provide a low electrical resistance adding to the risk removal and/or damage of the plating in the application. The disclosed hearing aid instead uses the second layer including palladium as the outer layer.

The second layer can have a hardness greater than the first layer. The second layer can have a hardness greater than the metallic component. Advantageously, the second layer can ensure a high wear resistance while keeping the first layer intact.

Having the first layer reduces and/or removes the risks of mud cracking which is typical in palladium plating as the layer underneath is more noble than the top layer driving the corrosion performance. Further, the second layer guards the first layer for safety, both mechanically and electrochemically. The second layer reduces and/or removes the risk of scratching and/or damaging in the first layer. Further, the only slight difference in electro-potential energy between the first layer and the second layer allows that, in a harsh environment, the first layer is not impacted.

Galvanic corrosion (dissimilar-metal corrosion) is an electrochemical process in which one metal corrodes preferentially, when in electrical contact with a different type of metal, and both metals are immersed in an electrolyte such as water.

The first layer can be protected chemically by the second layer. However, as the two have close reduction potential (Au 0.926 volts vs Pd. 0.915 volts). This means if something needs to be sacrificed, it is the second layer. However, as potential difference is close, this rate is significantly lower compared to other combinations such as Brass-Nickel-Au.

In one or more example hearing aids, the coating does not include nickel. For example, the coating does not include nickel and/or any nickel alloys. In other words, the second layer does not include nickel and the first layer does not include nickel. The coating can be nickel-free.

In one or more example hearing aids, the second layer has a thickness greater than a thickness of the first layer. For example, the second layer can be twice as thick as the first layer. Thickness can be understood as the average thickness of the particular layer (e.g., the second layer and the first layer. Thickness can be understood as the distance between an outer surface and an inner surface of the particular layer (e.g., the second layer and the first layer).

For example, the thickness of the first layer can be understood as the average distance between where the first layer is in contact with the metallic component and where the first layer is in contact with the second layer. For example, the thickness of the second layer can be understood as the average distance between where the second layer is in contact with the first layer and an outer surface of the second layer.

In one or more example hearing aids, the first layer has a thickness of between 0.1-0.5 μm. In one or more example hearing aids, the first layer has a thickness of between 0.14 and 0.26 μm. The first layer can have a thickness of 0.2+/−0.06 μm.

In one or more example hearing aids, the second layer has a thickness of between 0.5-1.0 μm. In one or more example hearing aids, the second layer has a thickness of between 0.5-0.8 μm. The second layer can have a thickness of 0.65+/−0.15 μm.

In one or more example hearing aids, the coating has a thickness of between 0.8-0.9 μm. The coating can have a thickness of 0.75-1.5 μm. The coating can have a thickness of 0.85 μm.

As discussed above, a thickness of between two numbers is inclusive of the endpoints. For example, a thickness of between 0.5-0.8 μm includes both 0.5 μm and 0.8 μm. Further, there may be variations of thickness of the respective layers and/or coating.

In some examples, the first layer can be an intermediate layer. In other words, the first layer is located between the metallic component and the second layer. The first layer can provide low electrical resistance while maintaining high corrosion resistance.

The electric charge contact of the hearing aid can have improved corrosion-resistance. In one or more example hearing aids, the electric charge contact has a corrosion performance, under ASTM B799-95, of at least 6 years without degradation. In one or more example hearing aids, the electric charge contact has a corrosion performance, under ASTM B799-95, of 1, 2, 3, 4, 5, or 6 years without degradation. The electric charge contact can have the corrosion performance equivalent to a 4.0 μm thick layer of standard gold plating.

In one or more example hearing aids, the first layer is plated on the metallic component. In one or more example hearing aids, the second layer is plated on the first layer. In one or more example hearing aids, the first layer is plated on the metallic component and/or the second layer is plated on the first layer. The first layer and/or the second layer can be electroplated. Other methods of applying the first layer and/or the second layer can be used as well. The first layer and/or the second layer are configured to be plated. The first layer and/or the second layer are configured to be electro-plated.

The disclosed hearing aid can be advantageous for soldering. Gold (found in the first layer) is very good at wetting during soldering performance, e.g., tin can easily tin. Further, gold is sharply reacting which is a positive aspect in manual soldering. However, in surface mount technology (SMT) processes, the oven requires more durations leading to tin travel out of the soldering interface. This will result into weaker soldering joints as the percentage of tin in the join is reduced. This will also increase the tolerances due to variation in tin travel. In contrast, the second layer including palladium provides good wetting, leading to a stable tin travel in soldering oven, and in turn higher soldering joint strengths. This can be attributed to much lower dissolution rates of palladium (e.g., in the second layer) in lead-free soldering compared to gold (e.g., in the corrosion resistant layer).

The hearing aid can include a processing unit. The processing unit can be configured to process signals, such as those received by an input unit for providing a signal to be output by the output unit.

The hearing aid can include a battery unit (e.g., battery). The battery unit can be configured to provide electrical power to one or more components of the hearing aid.

The hearing aid can include a hearing aid housing. The hearing aid housing can be configured to retain the processing unit, the battery unit, and one or more electric charge contacts according to the disclosure.

Also disclosed herein are electronic devices including the electric charge contact according to the disclosure.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a processing unit for enhancing the input signals and providing a processed output signal.

The hearing aid may comprise an output unit for providing a stimulus perceived by the user as an acoustic signal based on a processed electric signal. The output unit may comprise a number of electrodes of a cochlear implant (for a CI type hearing aid) or a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

The hearing aid may be constituted by or form part of a portable (i.e. configured to be wearable) device, e.g. a device comprising a local energy source, e.g. a battery unit, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, e.g. a headset, an earphone, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

### A Method

In an aspect, a method of manufacturing a hearing aid comprising an electric charge contact is disclosed. The method can include forming a metallic component configured to provide electrical conduction. The method can include applying a first layer at least partially located on the metallic component, wherein the first layer comprises gold. The method includes applying a second layer at least partially located on the first layer, wherein the second layer comprises palladium.

In one or more example methods, applying the first layer comprises plating the first layer. In one or more example methods, applying the second layer comprises plating the second layer.

In one or more example methods, applying the first layer comprises electro-plating the first layer. In one or more example methods, applying the second layer comprises electro-plating the second layer.

It is intended that some or all of the structural features of the hearing aid and/or the electric charge contact described above, in the ‘detailed description of embodiments’ or in the claims can be combined with embodiments of the method, when appropriately substituted by a corresponding process and vice versa. Embodiments of the method have the same advantages as the corresponding hearing aid and/or the electric charge contact.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears, acoustic signals transferred as mechanical vibrations to the user's inner ears through the bone structure of the user's head and/or through parts of the middle ear as well as electric signals transferred directly or indirectly to the cochlear nerve of the user.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, as an attachable, or entirely or partly implanted, unit, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 illustrates a schematic of an example of a hearing aid having an electric charge contact according to the disclosure,

FIG. 2 illustrates a schematic cross-section of an example of a hearing aid having an electric charge contact according to the disclosure,

FIG. 3 illustrates a graph of tin travel in gold-plated parts during soldering and the impact on the solder joint strength,

FIG. 4 shows corrosion performance of gold (left), nickel/gold (middle), and gold/palladium according to the disclosure,

FIG. 5 show plating integrity progress under a sulphur test,

FIG. 6 shows a method of manufacturing a hearing aid according to the disclosure, and

FIG. 7 shows an example hearing aid according to the disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

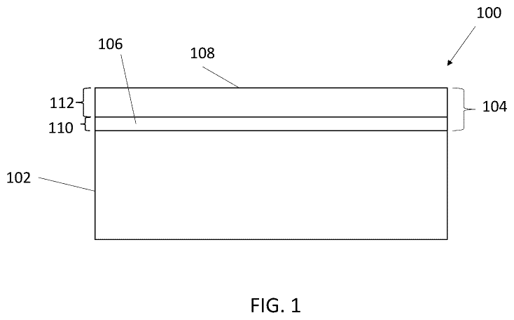

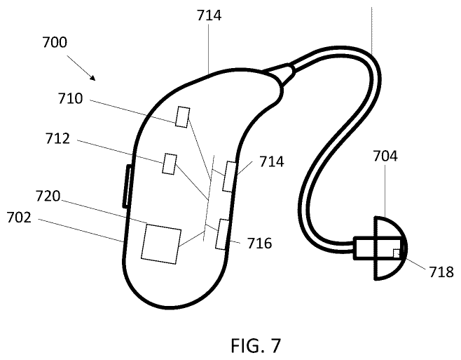

FIG. 1 illustrates a schematic of an example of a hearing aid (such as show in FIG. 7) having an electric charge contact according to the disclosure. In particular, FIG. 1 illustrates a schematic of an electric charge contact 100 that is incorporated into a hearing aid. The electric charge contact 100 can be utilized for any number of components that use an electrical signal.

The charge contact 100 can include a metallic component 102 configured to provide electrical conduction. Further, the charge contact 100 can include a coating 104 at least partially covering the metallic component 102. The coating 104 includes a first layer 106 at least partially located on the metallic component 102, wherein the first layer 106 includes gold. The first layer 106 can be understood as a gold layer. The coating further includes a second layer 108 at least partially located on the first layer 106, wherein the second layer 108 comprises palladium. The second layer 108 can be understood as a palladium layer 108. The second layer 108 can be pure palladium.

As shown in FIG. 1, the first layer 106 is located between the metallic component 102 and the second layer 108. The corrosion-layer 106 can act as an intermediate layer with the second layer 108 as the top layer.

As shown in FIG. 1, the second layer 108 can have a thickness greater than a thickness of the first layer 106. The first layer 106 can have a thickness of between 0.1-0.5 μm, preferably between 0.14 and 2.06 μm. The second layer 108 can have a thickness of between 0.5-1.0 μm, preferably between 0.5-0.8 μm. The coating 104 can have a thickness of between 0.8-0.9 μm.

Advantageously, the coating 104 may not include nickel, and thus there is no worry of nickel release.

The first layer 106 can be plated on the metallic component 102 and/or the second layer 108 can be plated on the first layer 106.

FIG. 1 also illustrates the thickness 110 of the first layer 106 and the thickness 112 of the second layer.

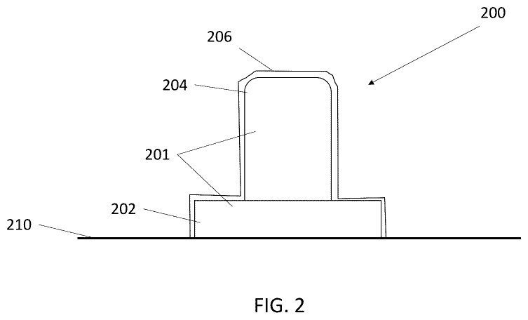

FIG. 2 illustrates a schematic cross-section of an example of a hearing aid having an electric charge contact according to the disclosure. The electric charge contact 200 can include any and/or all of the features of the electric charge contact 200 of FIG. 1. The electric charge contact 200 can be covered by a coating 206, which can include any and/or all of the features of coating 104 of FIG. 1. The metallic component 201 can include any and/or all of the features of metallic component 102 of FIG. 1.

The metallic component 201 can be stainless steel, such as stainless steel 316. The metallic component 102 can include a charging interface 204. The metallic component 102 can include a soldering interface 202.

As shown, the coating 206 fully covers the metallic component 102 (e.g., charging interface 204 and soldering interface 202). In other words, the first layer of the coating 206 fully covers the metallic component 201. Further, the second layer of the coating 206 fully covers the first layer.

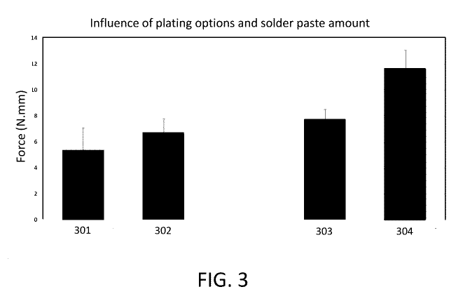

FIG. 3 illustrates a graph of tin travel in gold-plated parts during soldering and the impact on the solder joint strength. Bar 301 illustrates an Au 0.45-paste 80% reflow, bar 302 illustrates an AU 0.45-paste 125% reflow. Bar 303 illustrates a Pd 0.45-paste 80% reflow and bar 304 illustrates a Pd 0.45-paste 125% reflow. As shown, the use of palladium greatly increases the shear strength of a solder.

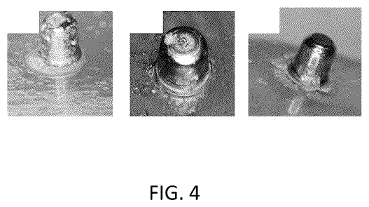

FIG. 4 shows corrosion performance of gold (left), nickel/gold (middle), and gold/palladium according to the disclosure. As shown, the gold/palladium metallic component exhibits much less corrosion than the other coated metallic components.

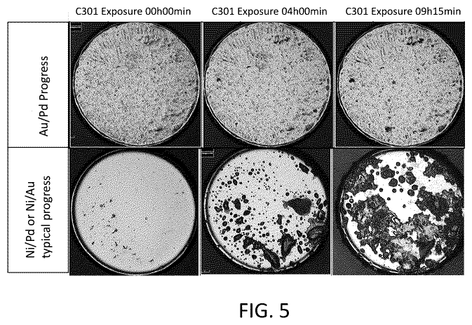

FIG. 5 show plating integrity progress under a sulphur test. In particular, the samples shown were tested under the conditions of ASTM B799-95 for consecutive 4 and 9 hours. The results show disintegration of the Ni/Au and Ni/Pd plating while the disclosed coating (Au/Pd) remains highly intact.

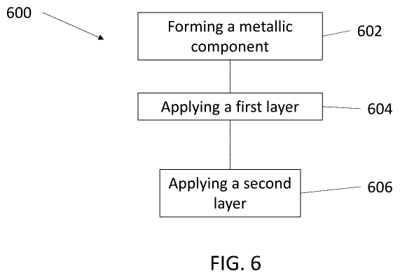

FIG. 6 shows a method 600 of manufacturing a hearing aid including an electric charge contact according to the disclosure. The method 600 includes forming 602 a metallic component configured to provide electrical conduction. The method 600 includes applying 604 a first layer at least partially located on the metallic component, wherein the first layer comprises gold. The method 600 includes applying 606 a second layer at least partially located on the gold layer, wherein the second layer comprises palladium.

As used herein, forming 602 a metallic component can include attaching a metallic component. For example, attaching a metallic component to a substrate of the hearing aid. Forming 602 can include soldering a metallic component.

Applying 604 the first layer can include plating. Applying 604 the first layer can include electro-plating.

Applying 607 the second layer can include plating. Applying 606 the second layer can include electro-plating.

FIG. 7 shows an example hearing aid according to the disclosure. As shown, the hearing aid 700 includes a hearing aid housing 714. The hearing aid 700 is configured to be worn behind the user's ears and comprises a behind-the-ear (BTE) part 702 and an in-the-ear part 704. The behind-the-ear part 702 is connected to the in-the-ear part 704 via connecting member 706. However, the hearing aid 700 may be configured in other ways e.g., as completely-in-the-ear hearing aids.

In the embodiment of a hearing aid in FIG. 7, the BTE part 702 comprises an input unit 710 including input transducers (e.g. microphones) for providing an electric input audio signal representative of an input sound. The input unit further comprises a wireless receiver 712 (or transceivers) for providing directly received auxiliary audio and/or control input signals (and/or allowing transmission of audio and/or control signals to other devices, e.g. to another hearing device, or to a remote control or processing device, or a telephone).

The hearing aid 700 includes a number of electronic components, such a memory 714, e.g. storing different hearing aid programs (e.g. parameter settings defining such programs, or parameters of algorithms) and/or hearing aid configurations, e.g. input source combinations, e.g. optimized for a number of different listening situations.

The hearing aid 700 further comprises a processing unit 716, such as configurable signal processor (DSP, e.g. a digital (audio) signal processor), e.g. including a processor for applying a frequency and level dependent gain, e.g. providing hearing loss compensation, beamforming, noise reduction, filter bank functionality, and other digital functionality of a hearing device. The processing unit 716 is adapted to access the memory 714. The processing unit 716 is further configured to process one or more of the electric input audio signals and/or one or more of the directly received auxiliary audio input signals, based on a currently selected (activated) hearing aid program/parameter setting (e.g. either automatically selected, e.g. based on one or more sensors, or selected based on inputs from a user interface).

The hearing aid 700 further comprises an output unit 718 (e.g. an output transducer) providing stimuli perceivable by the user as sound based on a processed audio signal from the processor or a signal derived therefrom.

The hearing aid 700 can further include a battery unit 720, such as for providing electrical power to one or more components of the hearing aid 700.

The above description only provides for some of the particular components of the hearing aid 700 for convenience. One or more of the components 710, 712, 714, 716, 718, 720 and/or other components can include the electric charge contact disclosed herein.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising a hearing aid housing having a processing unit, a battery unit, and an electric charge contact, wherein the electric charge contact comprises:
a metallic component configured to provide electrical conduction; and
a coating at least partially covering the metallic component, the coating comprising:
a first layer at least partially located on the metallic component, wherein the first layer comprises gold; and
a second layer at least partially located on the first layer, wherein the second layer comprises palladium.

2. Hearing aid of claim 1, wherein the metallic component is stainless steel.

3. Hearing aid of claim 2, wherein the stainless steel is stainless steel 316.

4. Hearing aid of claim 1, wherein the second layer has a thickness greater than a thickness of the first layer.

5. Hearing aid of claim 1, wherein the first layer has a thickness of between 0.1-0.5 μm, preferably between 0.14 and 0.26 μm.

6. Hearing aid of claim 1, wherein the second layer has a thickness of between 0.5-1.0 μm, preferably between 0.5-0.8 μm.

7. Hearing aid of claim 1, wherein the coating has a thickness of between 0.8-0.9 μm.

8. Hearing aid of claim 1, wherein the second layer is pure palladium.

9. Hearing aid of claim 1, wherein the coating does not include nickel.

10. Hearing aid of claim 1, wherein the first layer fully covers the metallic component.

11. Hearing aid of claim 1, wherein the second layer fully covers the corrosion-resistant layer.

12. Hearing aid of any one of the preceding claims, wherein the metallic component comprises a charging interface.

13. Hearing aid of claim 1, wherein the electric charge contact has a corrosion performance, under ASTM B799-95, of at least 6 years without degradation.

14. Hearing aid of claim 1, wherein the first layer is plated on the metallic component is plated on the corrosion-resistant layer.

15. Hearing aid of claim 1, wherein the second layer is plated on the corrosion-resistant layer.

16. Hearing aid of claim 1, wherein the first layer is plated on the metallic component and the second layer is plated on the corrosion-resistant layer.

17. A method of manufacturing a hearing aid comprising an electric charge contact, the method comprising:
forming a metallic component configured to provide electrical conduction;
applying a first layer at least partially located on the metallic component, wherein the first layer comprises gold; and
applying a second layer at least partially located on the first layer, wherein the second layer comprises palladium.

18. Method of claim 17, wherein forming the metallic component comprises attaching the metallic component to substrate.

19. Method of claim 17, wherein applying first layer comprises electro-plating.

20. Method of claim 17, wherein applying second layer comprises electro-plating.
